(19) United States
(12) Patent Application Publication
(10) Pub. No.: US 2020/0049098 A1
(43) Pub. Date: Feb. 13, 2020

(54) METHOD AND APPARATUS FOR CORRECTION OF PRESSURE WAVE AFFECTED FUEL INJECTION

(71) Applicants: HYUNDAI MOTOR COMPANY, Seoul (KR); KIA MOTORS CORPORATION, Seoul (KR)

(72) Inventors: Andreas KAPP, Eschborn (DE); Leigh DEISSENROTH, Mainz (DE)

(73) Assignees: HYUNDAI MOTOR COMPANY, Seoul (KR); KIA MOTORS CORPORATION, Seoul (KR)

(21) Appl. No.: 16/201,543

(22) Filed: Nov. 27, 2018

(30) Foreign Application Priority Data
Aug. 13, 2018 (DE) 102018213620.3

(51) Int. Cl. F02D 41/38; F02D 41/40; F02M 63/02

(52) U.S. Cl. CPC F02D 41/3863; F02D 41/403; F02D 2250/04; F02D 2200/0602; F02M 63/023

(57) ABSTRACT

A fuel injection system (1) of a combustion engine includes: at least one fuel injection actuator (3) to inject fuel into a cylinder (2) of the combustion engine, a high pressure fuel supply system to supply the fuel injection actuators (3) with fuel, and a control logic device (12) including an artificial neural network (12A) to calculate pressure correction data (pcd) used to correct pressure waves, PW, generated by at least one actuator of the fuel injection system (1).

### CROSS-REFERENCE TO RELATED APPLICATION

This application claims priority to and the benefit of German Patent Application No. 102018213620.3, filed on Aug. 13, 2018, the entire contents of which are incorporated herein by reference.

### FIELD

The disclosure relates to a method and apparatus for correction of pressure wave effected fuel injection of fuel injection actuators of a fuel injection system.

### BACKGROUND

The statements in this section merely provide background information related to the present disclosure and may not constitute prior art.

Combustion engines can use fuel injection systems to meet targets on performance, emission, noise and fuel efficiency. However, conventional storage accumulator injection systems are faced with pressure disturbances or pressure waves that have an impact on the fuel injection accuracy for a following injection in a negative way. These pressure disturbances reduce the engine performance of the combustion engine and reduce the emission noise and fuel efficiency of the combustion engine.

In a conventional combustion engine, the pressure disturbances and their effects on the fuel injection accuracy of the fuel injection system are compensated by control programs using correction algorithms which are based on the measurements of the pressure wave impact on fuel injection accuracy.

FIG. 1 illustrates the use of a conventional pressure wave control logic. Data from different kinds of sensors are supplied to the engine management system EMS and can be captured for each operation point by an application software. The appropriate acquisitions are checked, evaluated and used for the next application steps of the control logic. After the application software has been programmed, it is implemented in the engine management system EMS or engine control unit ECU to generate control signal for the different fuel injection actuators depending of received load point information data and measured pressure. Calculation of the control signals is complex and desires many resources at the electronic control unit ECU. Further, the calculations are difficult to calibrate requiring involvement of a team of engineers. Because of the complexity of the calculations and the calibration, we have discovered that this conventional approach is moreover error-prone and very inflexible with respect to changes to the fuel supply system and/or the combustion engine. In a conventional system the correction of pressure wave affected fuel injections is performed by an application program created by engineers based on their experience, i.e. the conventional system for correction of pressure wave affected fuel injection by fuel injection actuators into cylinders of combustion engine is not self-adaptive to changes within the system.

The above information disclosed in this Background section is only for enhancement of understanding of the background of the present disclosure and therefore it may contain information that does not form the prior art that is already known to a person of ordinary skill in the art.

### SUMMARY

The present disclosure provides a method and a system which provides precise correction of pressure wave affected fuel injection in a fully autonomous way.

In one form of the present disclosure, a fuel injection system of a combustion engine includes at least one fuel injection actuator, a high pressure fuel supply system, and a control logic device. The at least one fuel injection actuator is adapted to inject fuel into a cylinder of the combustion engine. The high pressure fuel supply system is adapted to supply the fuel injection actuators with fuel. The control logic device includes an artificial neural network adapted to calculate pressure correction data used to correct pressure waves generated by at least one actuator of the fuel injection system.

The fuel injection system according to the first aspect of the present disclosure has the advantage that it is fully self-adaptive and does not require pre-working by an engineer if there are changes in the system, in particular in the high pressure fuel supply system and/or the used combustion engine.

A further advantage of the fuel injection system according to the first aspect of the present disclosure is in that it improves the accuracy of pressure wave correction of pressure waves generated by actuators, in particular pressure waves generated by a high pressure pump and/or by a pressure control valve of the high pressure fuel supply system.

In one form, the present disclosure provides a method for correction of pressure wave affected fuel injection by fuel injection actuators of a fuel injection system.

The method for correction of pressure wave affected fuel injection by fuel injection actuators of a fuel injection system comprises the steps of:
calculating pressure correction data by an artificial neural network on the basis of pressure data provided by at least one pressure sensor and on the basis of load point information data, and
controlling the fuel injection actuators of the fuel injection system in response to the pressure correction data calculated by the artificial neural network.

In one form, the artificial neural network comprises a deep neural network having an input layer to receive input variables, at least one hidden layer, and an output layer to provide output variables.

In a further possible form of the fuel injection system, the artificial neural network is trained with training data sets provided for varying parameters of the fuel injection system and/or combustion engine.

In a still further possible form of the fuel injection system in the first aspect of the present disclosure, the high pressure fuel supply system comprises a high pressure pump adapted to pump fuel from a fuel reservoir into a common high pressure fuel rail adapted to supply the fuel injection actuators with high pressure fuel.

In a still further possible form of the fuel injection system in the first aspect of the present disclosure, the high pressure pump forms an actuator of said high pressure fuel supply system and generates pressure waves at each compression stroke of the high pressure pump.

In other form of the fuel injection system, the high pressure fuel supply system comprises a pressure control valve adapted to regulate a fuel pressure in the common high pressure fuel rail, wherein the pressure control valve forms an actuator of the high pressure fuel supply system and generates pressure waves when actuated.

In a still further possible form of the fuel injection system, the high pressure fuel supply system comprises at least one pressure sensor adapted to measure the pressure within the high pressure fuel supply system to provide pressure data supplied as input variables to the artificial neural network of the control logic device.

In a still further possible form of the fuel injection system, load point information data is supplied as input variables to the artificial neural network of the control logic device.

In a still further possible form of the fuel injection system, the artificial neural network is adapted to calculate pressure correction data as an output variable on the basis of the pressure data received from the at least one pressure sensor and on the basis of the received load point information data.

In a further possible form of the fuel injection system, pressure wave affected fuel injection is corrected according to the pressure correction data calculated by the artificial neural network of the control logic device by adjusting an energizing time and/or an energizing amplitude of each fuel injection actuator.

In a still further possible form of the fuel injection system, the fuel injection actuator is adapted to inject fuel into its associated cylinder of the combustion engine during a main injection and during one or more pilot injections preceding the main injection.

In a still further possible form of the fuel injection system, pressure wave affected fuel injection is corrected according to the pressure correction data calculated by the artificial neural network of the control logic device by controlling the energizing time and/or energizing amplitude of the main injection and/or pilot injections of the fuel injection actuators.

The present disclosure further provides a control logic device for a fuel injection system including an artificial neural network and a control unit. The artificial neural network is adapted to calculate pressure correction data used to correct pressure waves generated by at least one actuator of the fuel injection system. The control unit is adapted to generate control signals for the fuel injection actuators of the fuel injection system depending on the calculated pressure correction data.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a block diagram of a conventional fuel injection system;

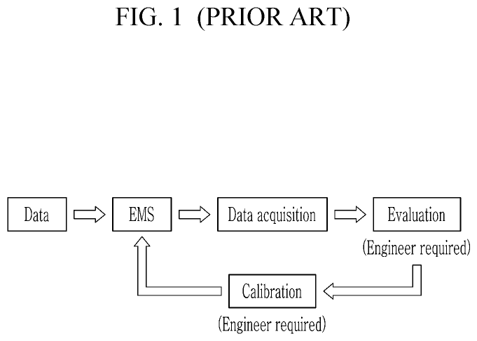

FIG. 2 shows a block diagram of a possible exemplary form of a fuel injection system in a first form of the present disclosure;

FIG. 3 shows a schematic diagram of an artificial neural network implemented in a control logic device of a fuel injection system in the first form of the present disclosure;

FIG. 4 shows a flowchart of a method for correction of pressure wave effected fuel injection in a second form of the present disclosure;

FIG. 5 schematically shows the generation of measurement data which can be used for training an artificial neural network implemented in a fuel injection system in one form of the present disclosure;

FIG. 6 shows a signal diagram for illustrating the operation of fuel injection system in one form of the present disclosure; and

FIGS. 7A-7D show signal diagrams for illustrating the correction of pressure waves by the method and system in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

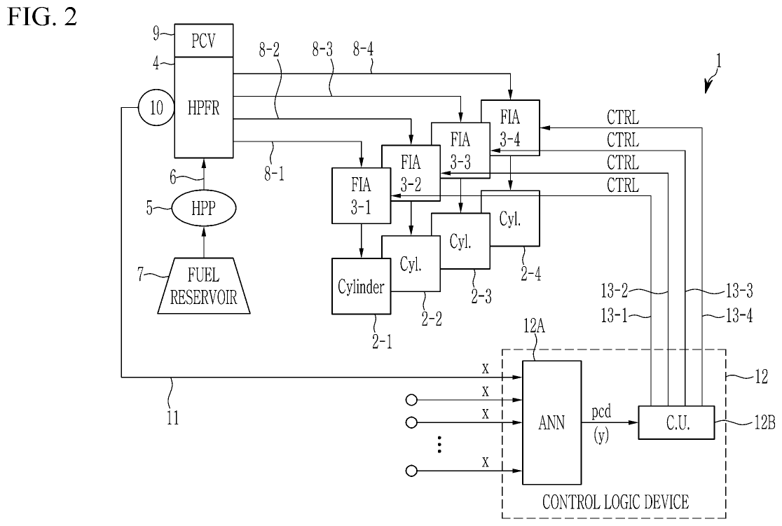

As can be seen in the block diagram of FIG. 2, a fuel injection system 1 in a first form of the present disclosure can be used in a combustion engine having one or more cylinders 2-1, 2-2, 2-3, 2-4 as illustrated in FIG. 2. Each cylinder of the combustion engine comprises an associated fuel injection actuator 3-1, 3-2, 3-3, 3-4 adapted to inject fuel into the corresponding cylinder of the combustion engine. The number of fuel injection actuators 3 and associated cylinders 2 can vary depending on the type of the combustion engine. A high pressure fuel supply system is adapted to supply the fuel injection actuators 3-i (i=1, 2, 3, 4) of the fuel injection system with fuel as illustrated in FIG. 2. The high pressure fuel supply system comprises in the illustrated exemplary form a common high pressure fuel rail 4 connected to a high pressure pump 5 by means of a high pressure pipe 6. The high pressure pump 5 is adapted to pump fuel from a fuel reservoir 7 into the common high pressure fuel rail 4 of the fuel supply system. The high pressure fuel rail 4 supplies each of the fuel injection actuators 3-i with fuel via high pressure pipes 8-i (i=1, 2, 3, 4) as illustrated in FIG. 2. The high pressure fuel supply system further comprises a pressure control valve 9 adapted to regulate a fuel pressure in the common high pressure fuel rail 4.

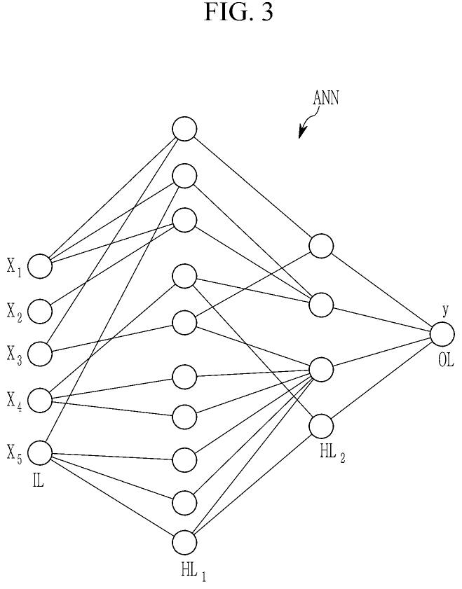

The high pressure fuel supply system further comprises at least one pressure sensor 10 adapted to measure the current pressure within the high pressure fuel supply system at a position within the high pressure fuel supply to provide pressure data supplied via a signal line 11 as in input variable “x” to an artificial neural network 12A of a control logic device 12 as shown in FIG. 2. The control logic device 12 comprises two main components in the illustrated exemplary form, i.e. the artificial neural network 12A and a control unit 12B. The artificial neural network 12A of the control logic device 12 is adapted to calculate pressure correction data “pcd” that can be used to correct pressure waves PW generated by at least one actuator of the system 1. The control unit 12B receives the calculated pressure correction data pcd from the artificial neural network 12A and is adapted to generate control signals CRTLs supplied to the different fuel injection actuators 3-i (i=1, 2, 3, 4) of the fuel injection system 1 depending on the calculated pressure correction data pcd. In the illustrated exemplary form of FIG. 2, the control unit 12B of the control logic device 12 controls the fuel injection actuators 3-1 to 3-4 via signal control lines 13-1 to 13-4. The artificial neural network 12A of the control logic device 12 is a trained artificial neural network having been trained on training data sets provided for varying parameters of the fuel supply system and/or the combustion engine. The artificial neural network 12A can comprise in a possible form a deep neural network. The deep neural network 12A comprises an input layer to receive input variables “x”, at least one hidden layer and an output layer to provide output variables “y”. In the diagram of FIG. 3 a possible exemplary form of such an artificial neural network (ANN) 12A is schematically illustrated.

The high pressure pump 5 of the fuel supply system forms an actuator which generates unwanted pressure waves PW at each compression stroke of the high pressure pump 5. Also the pressure control valve 9 forms an actuator of the high pressure fuel supply system which generates unwanted pressure waves PW when actuated. Also each fuel injection actuator 3-i can generate pressure waves PW when actuated. The pressure waves PW propagate through the pipes and affect the fuel injection by the fuel injection actuators 3-i negatively. A system pressure can be measured at a position in the high pressure fuel supply. The system pressure can be anything between a maximum pressure and a minimum pressure depending on engine and/or pump speed as well as the fuel amount and depending on several other impacting factors. The ideal information which is desired is the precise pressure at each fuel injection actuator 3-i in order to calculate the correct actuation of the respective fuel injection actuator 3-1 since the injected fuel quantity depends on the pressure at the location of the fuel injection actuator 3-i and the opening duration of the respective fuel injection actuator 3-i. However, this pressure information for each individual fuel injection actuator 3-i is not existing as a measurement signal. Only a calculation of this pressure information is possible and is performed by the control logic device 12 of the system 1. The pressure sensor 10 is adapted to measure the system pressure within the high pressure fuel supply system and supplies the pressure data as one of a plurality of input variables x to the artificial neural network 12A of the control logic device 12 as shown in FIG. 2. Other load point information data is also supplied as input variables x to the artificial neural network 12A of the control logic device 12. The artificial neural network 12A calculates pressure correction data pcd as an output variable y on the basis of pressure data received from at least one pressure sensor 10 and the remaining load point information data. Depending on the implementation and the use case, the load point information data can comprise a variety of different data including data related to the injection strategy of the fuel injection system. These load point information data can comprise for instance the number of injections, an injection timing, injection quantities and/or rail pressure of the common high pressure fuel rail 4. The load point information data supplied as variables x to the artificial neural network 12A can further comprise load point information data concerning the operation of the combustion engine such as engine speed, engine torque, environmental temperature, humidity or environmental pressure.

Further, input variables x supplied as load point information data to the artificial neural network 12A can comprise also parameters concerning the status of correction functions, in particular whether the pilot corrections and/or main corrections are active or not. In another form, the load point information data supplied as input variables x to the artificial neural network 12A can further comprise data concerning fuel properties of the fuel, in particular fuel temperature and/or fuel type (physical properties of the fuel).

In one form of the fuel injection system 1, the supplied input variables x can also include data concerning the hardware set-up of the fuel supply system and/or combustion engine. The supplied variables x can comprise information about the implemented hardware of the system such as length of the supply pipes, the pump type of the high pressure pump 5, the injector type of the used fuel injection actuators 3, volume of the common high pressure fuel rail 4, and information about the pressure control valve 9. These kind of information data is normally constant after implementation of the system, i.e., the fuel supply system and/or the combustion engine. However, the use of these input variables allows to use the control logic device 12 also for different types of combustion engines and/or fuel supply systems. Accordingly, the artificial neural network 12A can be trained for not only a single type of combustion engine or vehicle type, but for different types or variants of a combustion engine and/or motors.

The artificial neural network 12A calculates pressure correction data pcd as an output variable y supplied to the control unit 12B as shown in FIG. 2. The control unit 12B generates control signals CRTLs for the fuel injection actuators 3-i depending on the pressure correction data pcd calculated by the artificial neural network 12A. Accordingly, the pressure wave affected fuel injection is corrected automatically and continuously according to the pressure correction data pcd by the control logic device 12 by adjusting an energizing time ET and/or an energizing amplitude EA of each fuel injection actuator 3-i. In a possible implementation, each fuel injection actuator 3-i is adapted to inject fuel into its associated cylinder 2-i (i=1, 2, 3, 4) of the combustion engine during a main injection MI and during one or more pilot injections PI preceding the main injection. The pressure wave affected fuel injection is corrected according to the pressure correction data pcd calculated by the artificial neural network 12A of the control logic device 12 by controlling the energizing time ET and/or the energizing amplitude EA of the main injection MI and/or pilot injections PI performed by the fuel injection actuators 3-i.

The artificial neural network 12A implemented in the control logic device 12 can comprise several layers wherein each layer can comprise a plurality of calculating nodes. In another form, the artificial neural network 12A is a deep neural network DNN comprising an input layer IL, one or more hidden layers HL and an output layer OL. In a possible implementation, the artificial neural network 12A comprises an input layer IL, three hidden layers HL and an output layer OL. FIG. 3 shows schematically an artificial neural network 12A having an input layer IL, two hidden layers HL₁, HL₂ and an output layer OL. The number of nodes in the input layer corresponds to the number of input variables x supplied to the artificial neural network 12A. In the illustrated exemplary form of FIG. 3, the output layer OL comprises a single node providing an output variable y comprising the pressure correction data pcd supplied to the correction unit 12B. In a cycle or event, the output variable y can comprise a value for pilot energizing correction, main energizing correction and/or post energizing correction. The artificial neural network 12A is initially trained in a training set-up on a plurality of training data sets to adjust the weighting parameters between the nodes of the different layers. In another form, an artificial neural network 12A can continuously learn and progressively improve its performance also during operation of the injection fuel system 1 implemented in a vehicle. The different layers of the artificial neural network 12A as shown in FIG. 3 can perform different kinds of transformations on their respective input data. The signals travel from the first input layer through the hidden layers to the last output layer, possibly after traversing different layers multiple times. In one form, output variables y of the artificial neural network 12A can be stored temporarily and fed back to nodes of the input layer of the artificial neural network 12A. The different nodes of the artificial neural network 12A can apply different activation functions, in particular a cosine activation function, a Tanh activation function, a sigmoid activation function or a ReLU activation function. Depending on the use case, different activation functions can be implemented and trained by applying training data sets to the artificial neural network 12A.

The common rail fuel system can stabilize the rail pressure within a relative small margin to a nominal value. The high pressure pump 5 provides a high rail pressure and continuously delivers fuel F to the high pressure fuel rail 4. The pressure is monitored by the pressure sensor 10 and pressure data of the current pressure is supplied to the artificial neural network 12A. The common rail fuel supply system has the advantage that the fuel pressure is independent of the engine speed and load conditions. This allows for flexibility in controlling both, the fuel injection quantity and injection timing, and provides better spray penetration in mixing even at low combustion engine speeds and loads. Further, the common rail system provides for lower fuel pump peak torque requirements and improved noise quality of the engine.

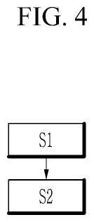

FIG. 4 shows a flowchart of an exemplary form of a method for correction of pressure wave affected fuel injection at fuel actuators in a fuel injection system.

As illustrated in FIG. 4, the method comprises two main steps.

In a first step S1 pressure correction data pcd are calculated by an artificial neural network ANN on the basis of pressure data provided by at least one pressure sensor and on the basis of received load point information data.

In a further step S2 fuel injection actuators of the fuel injection system are controlled in response to the pressure correction data calculated by the artificial neural network ANN.

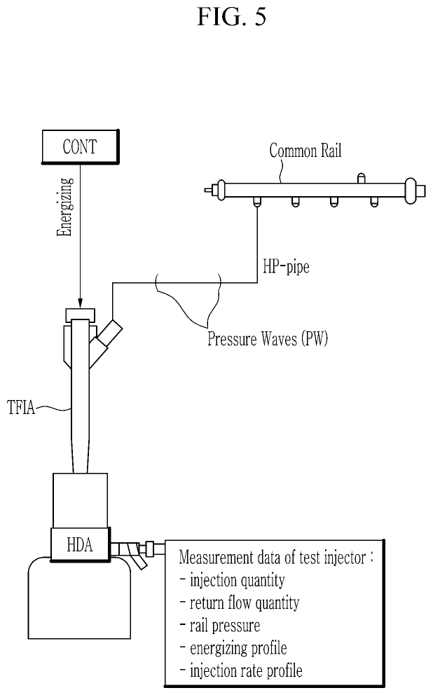

FIG. 5 schematically illustrates the generation of measurement data which can be used to train artificial neural networks such as the artificial neural network 12A illustrated in FIG. 2. The high pressure analyzing unit (HDA) is attached to a test fuel injection actuator TFIA connected via a high pressure pipe to a common high pressure fuel rail. The controller CONT energizes the test fuel injection actuator TFIA of the training set-up. The high pressure analyzing unit HDA provides measurement data which can be used for training of the artificial neural network ANN. Measurement data provided by the test fuel injection actuator TFIA can for instance comprise an injection quantity, a return flow quantity, a rail pressure, an energizing profile and/or an injection rate profile supplied as training data sets to the artificial neural network ANN.

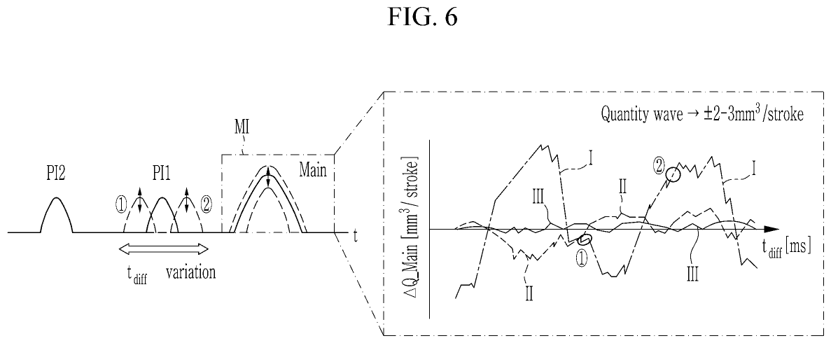

FIG. 6 shows a diagram illustrating the impact of pressure waves PW on a fuel metering accuracy. The pressure wave PW causes prior injections leading to deviations in the injected quantity (at constant energizing time). In the illustrated example of FIG. 6, a main injection MI is preceded by two pilot injections PI. The pilot injection PI2 has an impact on the pilot injection PI1 and the main injection MI. Further, the pilot injection PI1 has an impact on the following main injection MI. The impact depends on how many injections are made and on when the energizing of the respective injections start. The impacted main injection MI may show in a worst case deviations of up to 5 mm³ per stroke. FIG. 6 shows on the right side the impact on the main injection MI performed by a fuel injection actuator with and without corrected pressure waves PW. Curve I illustrates the impact of uncorrected pressure waves over time. Curve II illustrates correction of a pressure wave PW using a conventional pressure wave correction controller. Curve III illustrates a pressure wave correction PWC achieved by a control logic device 12 according to the present disclosure having an implemented trained artificial neural network 12A. As can be seen from FIG. 6 on the right side, with the method and apparatus according to the present disclosure the pressure waves PW generated by at least one actuator of the system, are almost completely cancelled or compensated.

The correction of the negative effects of pressure waves PW on the fuel injection is performed by adjusting the energizing time ET and/or the energizing amplitude EA of the respective injection. Depending on when the injection is released, the energizing time ET is set to an appropriate value. The control logic device 12 of the fuel injection system 1 provides for a precise elimination of pressure waves PW generated by actuators of the system, in particular generated by the high pressure pump 5 and the high pressure control valve 9.

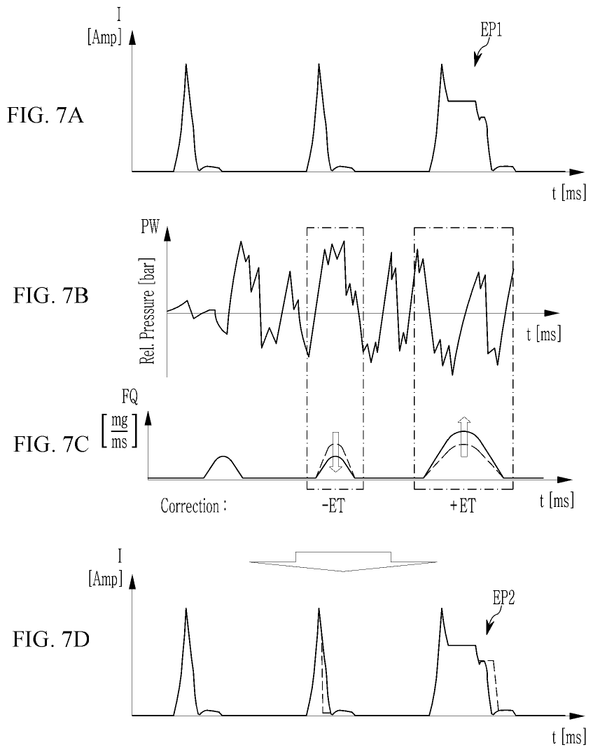

FIGS. 7A to 7D show signal diagrams for illustrating the correction of unwanted pressure waves PW using the method and apparatus.

FIG. 7A shows a first energizing profile EP1 of a control current applied to a fuel injection actuator 3. During operation of the fuel injection actuator 3, pressure waves PW are generated as illustrated in the signal diagram of FIG. 7B by actuators of the system 1.

FIG. 7C illustrates the fuel quantity FQ injected by the fuel injection actuator 3 in milligram per milliseconds.

FIG. 7D shows the corrected energizing profile EP2 being different from the first energizing profile EP1 in FIG. 7A. Depending on the input variables x including inter alia the pressure data, the energizing time ET and/or energizing amplitude EA are slightly adjusted to cancel or eliminate the unwanted pressure waves PW shown in FIG. 7B.

A fuel injection system 1 according to the present disclosure as illustrated for instance in FIG. 2, can be used for different kinds of vehicles, in particular road cars with Diesel engines. The fuel injection actuators 3 can comprise solenoid or piezo-electric valves controlled by the control unit 12B. The control unit 12B controls the fuel injection time and fuel injection quantity of the fuel injection actuators 3-i. The high pressure (e.g. over 100 bar) of the common rail fuel supply provides for better fuel atomization. To lower the noise of the combustion engine, the control unit 12B controls the injection of a small amount of fuel F before the main injection event, i.e. pilot injections PI. The high pressure fuel rail 4 which supplies the fuel injection actuators 3-i with fuel forms a pressure accumulator where the fuel F is stored at high pressure. This accumulator supplies multiple fuel injection actuators 3-i with high pressure fuel. This simplifies the operation of the high pressure pump 5 in that it only needs to maintain a target pressure which can be either mechanically or electronically controlled.

The fuel injection actuators 3-i are electrically activated by the control unit 12B. A hydraulic valve (consisting of a nozzle and plunger) can be mechanically or hydraulically opened and the fuel F is sprayed into the associated cylinder 2-i (i=1, 2, 3, 4) at the desired pressure. Since the fuel pressure energy is stored remotely and the fuel injection actuators 3-i are electrically actuated in response to the control signals CRTL received from the control unit 12B, the injection pressure at a start and at the end of injection is close to the pressure within the accumulator, i.e. at the high pressure fuel rail 4. According to the dimension of the accumulator, pump and plumbing, the injection pressure and rate can be almost the same for each of the multiple injection events.

The artificial neural network (ANN) 12A, the control unit 12B, the control logic device 12, the controller CONT, and the high pressure analyzing unit HDA may be realized as at least one microprocessor operated by a predetermined program, and the predetermined program may include a set of instruction to perform the above-described functions.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

What is claimed is:

1. A fuel injection system of a combustion engine, the fuel injection system comprising:
a fuel injection actuator adapted to inject fuel into a cylinder of the combustion engine;
a high pressure fuel supply system adapted to supply the fuel injection actuator with fuel; and
a control logic device comprising an artificial neural network adapted to calculate pressure correction data used to correct pressure waves generated by the fuel injection actuator.

2. The fuel injection system according to claim 1, wherein the artificial neural network comprises a trained artificial neural network.

3. The fuel injection system according to claim 1, wherein the artificial neural network comprises a deep neural network including:
an input layer to receive input variables,
at least one hidden layer; and
an output layer to provide output variables.

4. The fuel injection system according to claim 1, wherein the artificial neural network is trained with training data sets provided for varying parameters of the fuel injection system or the combustion engine.

5. The fuel injection system according to claim 1, wherein the high pressure fuel supply system comprises:
a high pressure pump adapted to pump fuel from a fuel reservoir into a common high pressure fuel rail adapted to supply the fuel injection actuators with high pressure fuel.

6. The fuel injection system according to claim 5, wherein the high pressure pump forms an actuator of the high pressure fuel supply system and generates pressure waves at each compression stroke of the high pressure pump.

7. The fuel injection system according to claim 1, wherein the high pressure fuel supply system comprises:
a pressure control valve adapted to regulate a fuel pressure in a common high pressure fuel rail,
wherein the pressure control valve forms an actuator of the high pressure fuel supply system and generates pressure waves when actuated.

8. The fuel injection system according to claim 1, wherein the high pressure fuel supply system comprises:
a pressure sensor adapted to measure a pressure within the high pressure fuel supply system to provide pressure data supplied as an input variable to the artificial neural network of the control logic device.

9. The fuel injection system according to claim 1, wherein load point information data is supplied as input variables to the artificial neural network of the control logic device.

10. The fuel injection system according to claim 1,
wherein the artificial neural network is adapted to calculate the pressure correction data (pcd) as an output variable based on pressure data received from a pressure sensor and load point information data.

11. The fuel injection system according to claim 1, wherein the pressure waves are corrected based on the pressure correction data (pcd) calculated by the artificial neural network of the control logic device by adjusting at least one of an energizing time (ET) or an energizing amplitude (EA) of the fuel injection actuator.

12. The fuel injection system according to claim 1, wherein the fuel injection actuator is adapted to inject fuel into the cylinder during a main injection and during a pilot injection preceding the main injection.

13. The fuel injection system according to claim 12, wherein the pressure waves are corrected based on the pressure correction data calculated by the artificial neural network of the control logic device by controlling at least one of an energizing time (ET), an energizing amplitude (EA) of the main injection, or the pilot injection of the fuel injection actuator.

14. A method for correction of pressure wave of an fuel injection actuator of a fuel injection system, the method comprising:
calculating pressure correction data by an artificial neural network based on load point information data and pressure data provided by a pressure sensor; and
controlling the fuel injection actuator of the fuel injection system in response to the pressure correction data calculated by the artificial neural network.

15. A control logic device for a fuel injection system, the control logic device comprising:
an artificial neural network adapted to calculate pressure correction data used to correct pressure waves generated by an actuator of the fuel injection system; and
a control unit adapted to generate control signals for an fuel injection actuator of the fuel injection system based on the calculated pressure correction data.
